(19) United States
(12) Patent Application Publication
(10) Pub. No.: US 2025/0008190 A1
(43) Pub. Date: Jan. 2, 2025

(54) DISPLAY APPARATUS AND METHOD FOR PROCESSING RECORDED DATA

(71) Applicant: VIDAA (NETHERLANDS) INTERNATIONAL HOLDINGS B.V., Duiven (NL)

(72) Inventors: Weiquan GONG, Duiven (NL); Yanbo CHANG, Duiven (NL); Jun HUANG, Duiven (NL)

(21) Appl. No.: 18/710,510

(22) PCT Filed: May 31, 2023
(86) PCT No.: PCT/EP2023/064549

§ 371 Date: May 15, 2024

(30) Foreign Application Priority Data
Aug. 30, 2022 (CN) 202211047037.0
Nov. 14, 2022 (CN) 202211424440.0

(51) Int. Cl. H04N 21/472; H04N 21/431; H04N 21/432

(52) U.S. Cl. CPC H04N 21/47217; H04N 21/431; H04N 21/4325

(57) ABSTRACT

Provided are a display apparatus and a method for processing recorded data. The display apparatus includes: a display configured to display an image; a communicator configured to be in communication with the network; a remote controller comprising a plurality of keys; a memory configured to store instructions and data associated with the display; and at least one processor in connection with the display, the communicator and the memory, and configured to execute the instructions to cause the display apparatus to perform: in response to a command for entering an interface for processing a recorded file, obtaining locations for resuming playing corresponding to recorded files and locating information for the locations for resuming playing; generating the interface for processing the recorded file and presenting the interface for processing the recorded file; presenting the one or more event controls on the display, and selecting a first event control by default.

### CROSS REFERENCE TO RELATED APPLICATIONS

The disclosure claims the priority to Chinese patent application No. 202211047037.0 filed on Aug. 30, 2022, and Chinese patent application No. 202211424440.0 filed on Nov. 14, 2022, which are incorporated in their entireties herein by reference.

### FIELD

The disclosure relates to the field of recorded data processing, and particularly relates to a display apparatus and a method for processing recorded data.

### BACKGROUND

Program recording is one of the functions for a smart television. When a user has no time to watch live broadcast programs on the smart television, the function of recording television programs can allow the user to record them in a local hard disk and watch the television programs later. In the related art, a file recorded through the function of recording television programs is a video file of pictures being played on the smart television. When the video file is replayed, the user would like to watch just a clip of the video file, and has to drag a progress bar to locate the desired clip. In this way, locating efficiency is low and operation steps are complex and inconvenient.

### SUMMARY

Embodiments of the present disclosure provide a display apparatus. The display apparatus includes: a display configured to display an image from a broadcasting system, a network and/or a user interface; a communicator configured to be in communication with the network; a remote controller including a plurality of keys; a memory configured to store instructions and data associated with the display; and at least one processor in connection with the display, the communicator and the memory, and configured to execute the instructions to cause the display apparatus to perform: in response to a command for entering an interface for processing a recorded file, obtaining one or more locations for resuming playing corresponding to one or more recorded files and one or more pieces of locating information for the one or more locations for resuming playing in the memory, wherein one of the one or more pieces of locating information includes event information and a recording progress, the event information is obtained according to information from a program source of a television program corresponding to the recorded file, and the one or more pieces of locating information is generated by the display apparatus according to the event information obtained from the program source and the recording progress during recording of the television program; generating the interface for processing the recorded file and presenting the interface for processing the recorded file on the display, wherein the interface for processing the recorded file includes a first recorded file control, and the first recorded file control is configured to present a location for resuming playing for a first recorded file and the event information in the locating information for the first recorded file; and in response to a command for displaying an event in the first recorded file, generating one or more event controls corresponding to one or more pieces of locating information in the first recorded file, presenting the one or more event controls on the display, and selecting a first event control by default, wherein the first event control among the one or more event controls is configured to skip to a first recording progress corresponding to the first event control for playing a portion of the first recorded file from the first recording progress, and the one or more pieces of location information in the first recorded file includes a piece of locating information for the location for resuming playing for the first recorded file and one or more pieces of locating information for one or more events in the first recorded file.

Embodiments of the present disclosure further provide a method for processing recorded data in a display apparatus. The method includes: in response to a command for entering an interface for processing a recorded file, obtaining one or more locations for resuming playing corresponding to one or more recorded files and one or more pieces of locating information for the one or more locations for resuming playing in the memory, wherein one of the one or more pieces of locating information includes event information and a recording progress, the event information is obtained according to information from a program source of a television program corresponding to the recorded file, and the one or more pieces of locating information is generated by the display apparatus according to the event information obtained from the program source and the recording progress during recording of the television program; generating the interface for processing the recorded file and presenting the interface for processing the recorded file on a display of the display apparatus, wherein the interface for processing the recorded file includes a first recorded file control, and the first recorded file control is configured to present a location for resuming playing for a first recorded file and the event information in the locating information for the first recorded file; and in response to a command for displaying an event in the first recorded file, generating one or more event controls corresponding to one or more pieces of locating information in the first recorded file, presenting the one or more event controls on the display, and selecting a first event control by default, wherein the first event control among the one or more event controls is configured to skip to a first recording progress corresponding to the first event control for playing a portion of the first recorded file from the first recording progress, and the one or more pieces of location information in the first recorded file includes a piece of locating information for the location for resuming playing for the first recorded file and one or more pieces of locating information for one or more events in the first recorded file.

### BRIEF DESCRIPTION OF THE DRAWINGS

FIG. 1 is a schematic diagram of an operation scenario between a display apparatus and a control device according to some embodiments of the disclosure.

FIG. 2 is a block diagram of hardware configuration of a control device 100 according to some embodiments of the disclosure.

FIG. 3 is a block diagram of hardware configuration of a display apparatus 200 according to some embodiments of the disclosure.

FIG. 4 is a schematic diagram of software configuration of a display apparatus 200 according to some embodiments of the disclosure.

FIG. 5 is a schematic flow diagram of a method for recording a television program according to some embodiments of the disclosure.

FIG. 6 is a schematic flow diagram of a method for recording a television program according to some embodiments of the disclosure.

FIG. 7 is a schematic flow diagram of a method for displaying a recorded file according to some embodiments of the disclosure.

FIG. 8 is a schematic diagram of an interface for processing a recorded file according to some embodiments of the disclosure.

FIG. 9 is a schematic diagram of an interface for processing a recorded file according to some embodiments of the disclosure.

FIG. 10 is a schematic diagram of an interface for processing a recorded file according to some embodiments of the disclosure.

FIG. 11 is a schematic diagram of an interface for processing a recorded file according to some embodiments of the disclosure.

FIG. 12 is a schematic flow diagram of a method for replaying a recorded file according to some embodiments of the disclosure.

FIG. 13 is a schematic diagram of an interface for replaying a recorded file according to some embodiments of the disclosure.

FIG. 14 is a schematic diagram of a recording mode of a display apparatus according to some embodiments of the disclosure.

FIG. 15 is a schematic diagram of a scenario of a method for locating and playing streaming media in a recording mode according to some embodiments of the disclosure.

FIG. 16 is a schematic diagram of a scenario of a method for locating and playing streaming media in a replay mode according to some embodiments of the disclosure.

FIG. 17 is a schematic diagram of recording according to a keyword in a recording command from a user according to some embodiments of the disclosure.

FIG. 18 is a schematic diagram of recording according to a key time point in a recording command from a user according to some embodiments of the disclosure.

FIG. 19 is a schematic diagram of a replay mode of a user interface according to some embodiments of the disclosure.

FIG. 20 is a schematic diagram of viewing an event list in a user interface according to some embodiments of the disclosure.

FIG. 21 is a schematic diagram of locating and playing streaming media in a user interface according to an event input from a user according to some embodiments of the disclosure.

FIG. 22 is a sequence diagram of a method for locating and playing streaming media according to some embodiments of the disclosure.

### DETAILED DESCRIPTION OF THE EMBODIMENTS

For making objectives and embodiments of the disclosure clearer, embodiments of the disclosure will be clearly and completely described below in combination with the accompanying drawings in the embodiments of the disclosure. Apparently, the embodiments described are merely some embodiments rather than all embodiments of the disclosure.

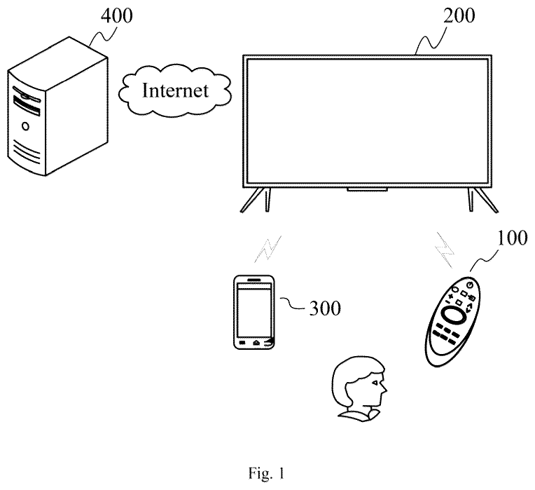

FIG. 1 is a schematic diagram of an operation scenario between a display apparatus and a control device according to some embodiments of the disclosure. As shown in FIG. 1, a user may operate the display apparatus 200 by means of an intelligent device 300 or a control device 100.

In some embodiments, the control device 100 may be a remote controller. Communication between the remote controller and the display apparatus 200 includes at least one of infrared protocol or Bluetooth protocol communication, or other short-distance communication. The control device 100 controls the display apparatus 200 in a wireless or wired mode. The user may input a user command through keys on the remote controller, voice input, control panel input, etc., so as to control the display apparatus 200.

In some embodiments, the intelligent device 300 is configured to control the display apparatus 200. For example, an application running on the intelligent device 300 is used to control the display apparatus 200.

In some embodiments, the intelligent device 300 may include any one of a mobile terminal, a tablet computer, a computer, a notebook computer, an augmented reality (AR)/virtual reality (VR) device, etc.

In some embodiments, the display apparatus 200 directly receives voice command from the user by means of a module configured to obtain a voice command in the display apparatus 200. Alternatively, the display apparatus 200 receives a voice command from the user by means of a voice control device arranged outside the display apparatus 200.

In some embodiments, the display apparatus 200 is further in data communication with a server 400. The display apparatus 200 may be in communication connection with other networks through a local area network (LAN) and a wireless local area network (WLAN). The server 400 may provide various contents and interactions for the display apparatus 200.

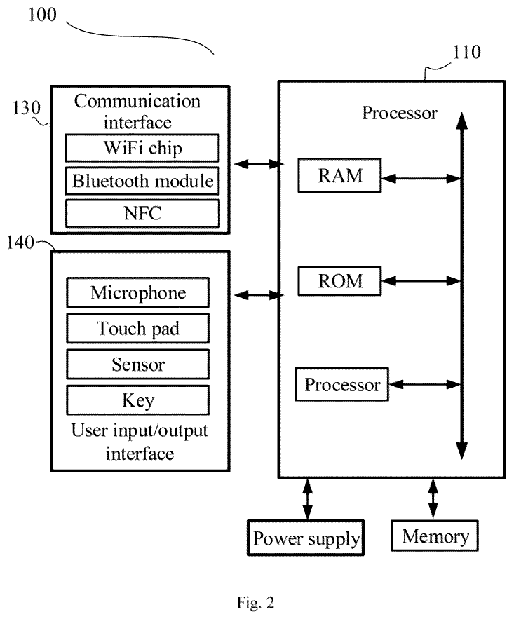

FIG. 2 is a block diagram of configuration of a control device 100 according to some embodiments of the disclosure. As shown in FIG. 2, the control device 100 includes at least one processor 110, a communication interface 130, a user input/output interface 140, a memory, and a power supply. The control device 100 may receive an operation command from the user, and convert the operation command into an instruction that the display apparatus 200 may recognize and respond.

In some embodiments, the communication interface 130 is configured to be in communication with an external device. The communication interface 130 includes at least one of a WIFI chip, a Bluetooth module, near-field communication (NFC), or other communication modules.

In some embodiments, the user input/output interface 140 includes at least one of a microphone, a touch pad, a sensor, a key, etc.

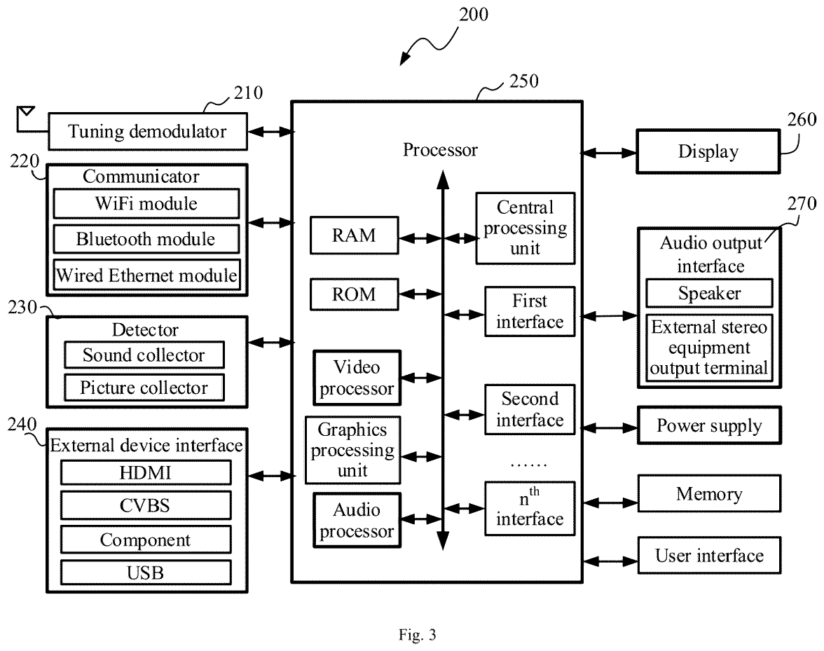

FIG. 3 is a block diagram of hardware configuration of a display apparatus 200 according to some embodiments of the disclosure.

As shown in FIG. 3, the display apparatus 200 includes at least one of a tuning demodulator 210, a communicator 220, a detector 230, an external device interface 240, at least one processor 250, a display 260, an audio output interface 270, a power supply, a memory, and a user interface.

In some embodiments, the tuning demodulator 210 receives a broadcasting system signal through wired or wireless reception, and demodulates an audio and video signal, for example, an electronic program guide (EPG) data signal, from a plurality of wireless or wired broadcasting television signals.

In some embodiments, the communicator 220 is configured to be in communication with the external device or the server according to various communication protocols. The communicator 220 includes at least one of a Wifi module, a Bluetooth module, a wired Ethernet module, or other network communication protocol chips or near-field communication protocol chips, and an infrared receiver. The display apparatus 200 may be in communication connection with an external device (for example, the control device 100) or the server 400 by means of the communicator 220.

In some embodiments, the detector 230 is configured to collect signals from external environment or a signal for interacting with outside. The detector 230 includes a sound collector and an image collector. For example, the sound collector may be a microphone configured to receive external sound; and the image collector may be a camera configured to collect an external scenario, an interactive gesture, etc. In some embodiments, the detector 230 further includes an optical receiver configured to collect ambient light intensity.

In some embodiments, the external device interface 240 may include: any one or more of a high-definition multimedia interface (HDMI), a composite video broadcast signal (CVBS) input interface, an analog or data high-definition component input interface (component), a universal serial bus (USB) input interface, a red green blue (RGB) port, etc.

In some embodiments, the at least one processor includes a video processor, a graphics processing unit (GPU), an audio processor, a central processing unit (CPU), and a first interface to an nth interface for input/output.

In some embodiments, the video processor is configured to perform video processing such as decompression, decoding, scaling, noise reduction, frame rate conversion, resolution conversion and picture synthesis on external video signals received according to a standard encoding and decoding protocol of the external video signals, so as to obtain signal for play on the display apparatus 200.

In some embodiments, the video processor includes a demultiplexing module, a video decoding module, an image synthesis module, a frame rate conversion module, a display formatting module, etc. The demultiplexing module is configured to conduct demultiplexing on an audio and video data stream input. The video decoding module is configured to process a video signal subjected to demultiplexing, for example, decoding and scaling the video signal. The image synthesis module, for example, an image synthesizer, is configured to superimpose and mix a graphical user interface (GUI) signal generated by a graphic generator according to input from the user or generated by the graphic generator and a scaled video picture, so as to generate an image signal to be displayed. The frame rate conversion module is configured to convert a frame rate of an input video. The display formatting module is configured to convert an output signal of a video after frame rate conversion so as to conform to a display format, for example, output a RGB data signal.

In some embodiments, the graphics processing unit is configured to generate various graphic objects, such as an icon, an operation menu, and a graphic displayed according to a command input from the user. The graphics processing unit includes an arithmetic unit configured to conduct arithmetic processing by receiving various interactive commands input from the user and displays various objects according to display attributes. The graphics processing unit further includes a renderer configured to render various objects obtained by the arithmetic unit, where the rendered objects are configured to be shown on the display.

In some embodiments, the audio processor is configured to receive an external audio signal, and conduct processing such as decompression, decoding, noise reduction, digital-to-analog conversion and enlargement according to a standard encoding and decoding protocol of the input signal, so as to obtain signals for being played in a speaker.

In some embodiments, the display 260 includes a panel component configured to present an image, and a driving component configured to drive picture display. The display 260 receives an image signal output from the at least one processor 250, displays a video content and an image content, and further may display some user interfaces. In addition, the image signal and the user interfaces may be displayed simultaneously. The display 260 may be a liquid crystal display, an organic light emitting diode (OLED) display, or a projection display, or may be a projection device or a projection screen.

In some embodiments, the user inputs a user command to a graphical user interface (GUI) displayed on the display 260, and a user input interface receives the user command through the GUI. Alternatively, the user inputs the user command by inputting specific sound or gesture, and the user input interface recognizes the sound or gesture by means of the sensor, so as to receive the user command.

In some embodiments, the audio output interface 270 includes a speaker and an external audio output terminal.

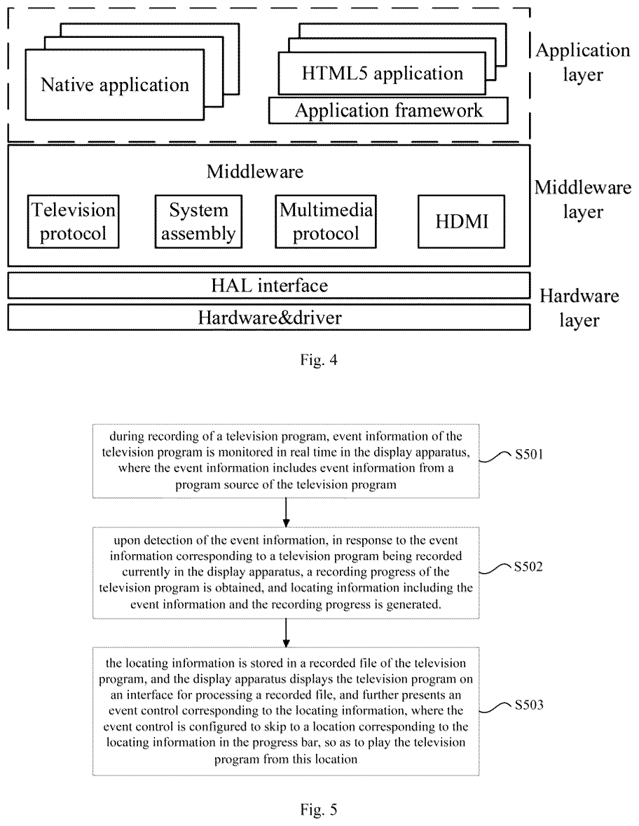

FIG. 4 shows a system of a display apparatus according to some embodiments of the disclosure. As shown in FIG. 4, the system of the display apparatus is divided into three layers, including an application layer, a middleware layer, and a hardware layer.

The application layer includes common applications on a television and an application framework. The common applications are mainly applications developed on the basis of the Browser, such as HTML5 applications (APPs) and native APPs.

As a complete application model, the application framework has all basic functions required by standard application software, such as file access and data exchange, and use interfaces of the functions, such as a toolbar, a status bar, a menu, and a dialog box, etc.

In the embodiments of the disclosure, an application framework layer includes managers, a content provider, etc. The managers include at least one of the following managers: an activity manager, a location manager, a package manager, a notification manager, and a window manager.

In some embodiments, the activity manager is configured to interact with all activities running in the system; the location manager is configured to provide system services or applications with access to system location services; the package manager is configured to retrieve all types of information related to application packages currently installed on the apparatus; the notification manager is configured to display and remove notification messages; and the window manager is configured to manage icons, windows, toolbars, wallpapers and a desktop on the user interface.

In some embodiments, the activity manager is configured to manage a life cycle of an application and general navigation back functions, such as exiting, launching and navigation back of the application. The window manager is configured to manage all window applications, for example, by obtaining a size of a display screen, determining whether there is a status bar, locking a screen, intercepting the screen, controlling change of a display window (such as shrinking, shaking and distorting the display window), detecting whether a cursor mode is enabled, and controlling a cursor to move to a location after the cursor mode is enabled. For example, the window manager may call a display parameter of the cursor after detecting that the cursor mode is enabled, and control the cursor to present on the screen according to the display parameter of the cursor, and may move the cursor to a target location on the screen according to a cursor move command received.

The native APPs may work online or offline, message push, or local resource access.

The middleware layer includes various television protocols, system components, multimedia protocols, HDMI protocols, or other middleware. The middleware may connect all parts of an application system or different applications in a network by using basic services or functions provided by system software, such that resource sharing and function sharing may be achieved.

The hardware layer includes a hardware abstraction layer (HAL) interface, hardware, and a driver. The HAL interface is a unified interface connected to all television chips. A specific logic is implemented by a chip. The driver includes: an audio driver, a display driver, a Bluetooth driver, a camera driver, a WIFI driver, a USB driver, a HDMI driver, a sensor driver (for example, a fingerprint sensor, a temperature sensor, a pressure sensor, etc.), a power driver, etc.

In some embodiments, the display apparatus may be a television or a monitor with broadcast program receiving function, and supports program recording. The user may enable the function of recording a television program when the display apparatus plays the television program. The display apparatus may store a recorded television program in a built-in hard disk, such that the user may replay the television program in spare time. Alternatively, the user may record the television program while watching the television program.

In some embodiments, when the user replays the television program, the user may need to adjust a playing progress of the television program to a point of a program content that the user desires to watch, and the user may adjust the playing progress by dragging a progress bar of the television program.

Because the user may not know about the playing progress of the content that the user desires to watch in the television program, the user needs to adjust the progress bar several times so as to adjust the playing progress to the desired point.

In order to avoid multi-time tedious progress adjustment, an embodiment of the disclosure provides a method for recording a television program, a method for replaying a television program, and a display apparatus for executing the above methods. FIG. 5 shows a flow of recording a program according to event information from a program source of a television program according to some embodiments of the disclosure. As shown in FIG. 5, the method for recording a television program includes: S501, S502, and S503.

S501: during recording of a television program, event information of the television program is monitored in real time in the display apparatus, where the event information includes event information from a program source of the television program.

The event information from the program source may be referred to as first event information.

In some embodiments, the program source may be a digital television (DTV) program data source, for example, a cable program based on a digital video broadcasting (DVB) standard, a satellite program, etc.

In some embodiments, after the display apparatus switches a signal source to a television program source and enters a broadcasting channel, the program source of the television program transmits a broadcasting stream of the broadcasting channel and EPG data to the display apparatus in real time, such that the display apparatus may play the television program corresponding to the broadcasting stream. The broadcasting channel may work according to DTV protocols, integrated services digital broadcasting (ISDB), sistema brasileiro detelevisão digital (SBTVD), advanced television systems committee (ATSC), and other standard protocols.

The EPG data may include channel data of each broadcasting channel, event information table (EIT) data, etc. The channel data may include a channel identity (ID), a channel name, a program ID and a program name of the program being currently played, etc., such that the display apparatus may display the channel name, the program name, etc. to the user when a channel is switched.

The EIT data may be set by an operator of the program source of the television program, and is configured to describe the event information in the television program. The event information includes channel information of a channel to which an event belongs, program information of a program to which the event belongs, an event name, start time of the event, a time length of the event, a running state of the event, detail information of the event, etc. The channel information in the event information may be the channel ID or the channel name. The program information of the program to which the event belongs may include the program ID or the program name of the television program.

In some embodiments, if the television program is a ball game and the ball game includes three games, the program source of the television program transmits corresponding event information to the display apparatus in a period of each game.

The EIT data includes event information of all television channels. The event information of different channels may be distinguished according to channel names or channel IDs. At a certain moment, some television channel may have no event information. In this case, the event information of the television channel in the EIT data may be void.

Event information of a current broadcasting channel may correspond to the television program being currently played on the display, or may correspond to a television program not yet played, for example, a next television program to be played in the future. The event information has a program parameter. The program parameter is configured to determine whether the event information corresponds to the television program being currently played or not. For example, if the program parameter in the event information is a first parameter, the event information corresponds to the current program being currently played on the display. If the program parameter is not the first parameter, the event information does not correspond to the current program being currently played on the display.

In some embodiments, for different program sources, the event information monitored by the display apparatus may be an event from a front end, for example, EPG information. Alternatively, the event information monitored by the display apparatus may be an event edited manually by the user. For example, a label may be set to represent an event.

In some embodiments, during playing of the television program, the user may record programs by means of a video recording application. For example, the user records the television program by using a personal video recorder (PVR) application. During recording of the program, the display apparatus monitors the event information from the program source of the television program in real time.

S502: upon detection of the event information, in response to the event information corresponding to a television program being recorded currently in the display apparatus, a recording progress of the television program is obtained, and locating information including the event information and the recording progress is generated.

In some embodiments, the event information may include the EPG information or a label edited manually by the user, which is information already read by the user, and the event information is associated with a file location, such that the user may determine a content of a file to be played on the basis of an association relationship. For example, the file location may be a location of the recording progress of the television program.

In some embodiments, within duration of an event corresponding to a piece of event information, the program source of the television program continuously transmits the same event information. After the display apparatus receives an EIT for the first time, the EIT may be locally stored, and then whether event information in the EIT is the same as historical event information in EIT received last time may be determined after an EIT is received later. If so, the EIT received this time is not processed, and alternatively, if not, the EIT locally stored is updated, and an event update notification is generated. The event update notification includes at least one of a channel ID and a program ID with event update, an event name, an event ID, and other information. For example, EIT information has a unique identifier to determine whether a first EIT identifier in the event information in the EIT is the same as a second EIT identifier in the historical event information in the EIT received last time. If the first EIT identifier is the same as the second EIT identifier, the event information in the EIT is determined to be the same as the historical event information in the EIT received last time. If the first EIT identifier is not the same as the second EIT identifier, the event information in the EIT is determined to be not the same as the historical event information in the EIT received last time. In some embodiments, if the event information in the EIT is determined to be the same as the historical event information in the EIT received last time, information, duplicate with the historical event information in the EIT received last time, in the EIT received this time is discarded.

In some embodiments, the event information may include an event name, event description, event time, and other parameters. In some embodiments, after the display apparatus generates an event update notification, a channel identifier of a television program being currently recorded may be obtained according to a current recording state of the display apparatus; whether the channel identifier is the same as a channel identifier of at least one piece of event information in the event update notification is determined; and if the channel identifier is the same as the channel identifier of at least one piece of event information in the event update notification, a program parameter of the at least one piece of event information is obtained, and whether a program corresponding to the at least one piece of event information is the television program being currently played is determined. For example, when the program parameter in the event information is a first parameter, the event information corresponds to the television program being currently played. When the program parameter is not the first parameter, the event information does not correspond to the television program being currently played. In some embodiments, the display apparatus does not process the event information that does not correspond to the television program being currently played. That is, the display apparatus processes the event information associated with the television program being currently played and does not process the event information not associated with the television program being currently played.

In some embodiments, if a television program currently recorded is the same as one of television programs corresponding to an event update notification, a current recording progress may be obtained, and the locating information including the event information and the recording progress may be generated, such that the event information may be associated with the recording progress.

S503: the locating information is stored in a recorded file of the television program, and the display apparatus displays the television program on an interface for processing a recorded file, and further presents an event control corresponding to the locating information, where the event control is configured to skip to a location corresponding to the locating information in the progress bar, so as to play the television program from this location.

In some embodiments, after the display apparatus generates the locating information, the locating information may be stored in the recorded file of the television program. The recorded file further includes a video stream file of a recorded program. Attribute information of the video stream file may include a channel code, a television program name, recording time, a size and a data format of the recorded file, and other information.

In some embodiments, during recording of a television program, the display apparatus may generate a plurality of pieces of locating information, which correspond to different pieces of event information of the television program from the program source of the television program respectively.

In some embodiments, during recording of the television program while the television program is being watched by a user, the user still may also want to manually input event information. To satisfy this need, an embodiment of the disclosure further provides another method for recording a program. As shown in FIG. 6, the method includes S601-S604.

S601: during recording of a television program, first event information from a program source of the television program and an event creation command input from a user are monitored in real time.

In some embodiments, event information from the program source of the television program may be referred to as the first event information, and event information input from the user may be referred to as second event information.

When the user records the television program while watching the television program on a display apparatus, if the user finds that a content being currently played is interesting, the user may manually input event information through an event creation command, so as to quickly skip to the recording progress in later replaying process.

When recording the television program by means of a PVR application, the user may wake up a voice assistant through a preset key on a remote controller or voice and input an event creation command. The display apparatus may generate an event creation layer in response to the event creation command, and the event creation layer may receive a name of event information input from the user, event introduction and a recording progress corresponding to the event. After input from the user is completed, the display apparatus generates the second event information including the name of the event information, where the recording progress corresponding to the event may be automatically determined by default according to a time when the event creation command is received, and the user may edit the recording progress.

In some embodiments, the event creation layer may be configured to be located above a layer of a recording interface. That is, the recording interface does not include the event creation layer, and the layer of the recording interface and the event creation layer are two different layers, such that when the user replays the television program, a playing interface does not display the event creation layer. In this way, the event creation layer is prevented from blocking the playing interface, and a replaying effect is improved.

S602: in response to detection of the first event information and the first event information corresponding to a television program being currently recorded, first locating information of the television program is generated, where the first locating information includes the first event information and a first recording progress corresponding to the first event information.

In some embodiments, locating information corresponding to the event information from the program source of the television program may be referred to as the first locating information, and a recording progress corresponding to the first locating information may be referred to as the first recording progress.

S603: in response to reception of the event creation command second locating information of the television program is generated, where the second locating information includes the second event information input from the user and a second recording progress corresponding to the second event information.

In some embodiments, locating information corresponding to the event information input from the user may be referred to as the second locating information. When the display apparatus receives the second event information, a current recording progress may be obtained.

The recording progress may be referred to as the second recording progress. The display apparatus may generate the second locating information according to the second recording progress and the second event information.

In some embodiments, the second recording progress may also be a recording progress when the display apparatus receives the event creation command. The recording progress is earlier than a recording progress when the user completes inputting of the second event information. The recording progress is used as a start moment corresponding to the second event information, which satisfies user's need better.

S604: the first locating information and the second locating information are stored in a recorded file of the television program, such that the display apparatus displays the television program on an interface for processing a recorded file, and further displays a first event control corresponding to the first locating information and a second event control corresponding to the second locating information, where the first event control is configured to skip to a first location corresponding to the first locating information so as to play the television program from the first location, and the second event control is configured to skip to a second location corresponding to the second locating information so as to play the television program from the second location.

In some embodiments, the display apparatus may store both the first locating information and the second locating information in the recorded file of the television program in a time order of the recording progress. In this way, the display apparatus may display the first event control and the second event control on the interface for processing the recorded file in the time order of the recording progress, such that the user may select an event control corresponding to an event that the user desires to watch according to the recording progress, and further the display apparatus may skip to a location corresponding to the event control selected by the user.

In some embodiments, the display apparatus may store both the first locating information and the second locating information in the recorded file of the television program according to event types. The event types include a first type and a second type. The first type indicates that the event information is from the program source of the television program, and the second type indicates that the event information is created by the user. The first locating information has a first type parameter for indicating that the event type is the first type, and the second locating information has a second type parameter for indicating that the event type is the second type. In this way, the display apparatus may display the first event control and the second event control on the interface for processing the recorded file according to the event types, such that the user may select the event control corresponding to the event that the user desires to watch according to the event type, and further the display apparatus may skip to a location corresponding to the event control selected by the user. Event controls of the same type may be sorted according to the recording progress.

Based on the above locating information, the display apparatus may display the event control on the interface for processing the recorded file, such that the user may skip, on the interface for processing the recorded file, to a recording location corresponding to an event of interest for the user.

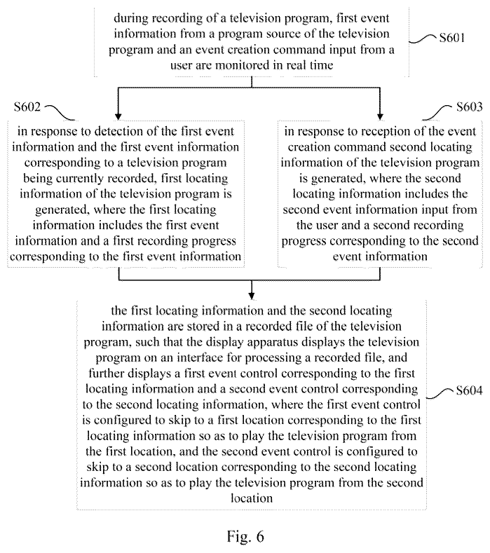

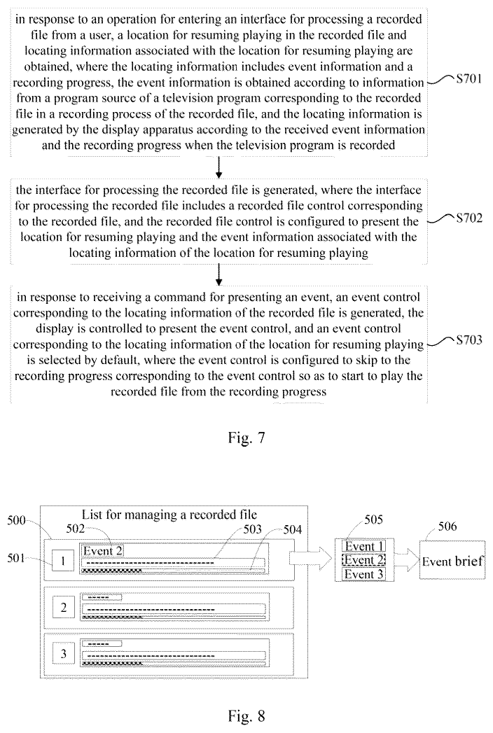

FIG. 7 is a schematic diagram of a flow of displaying a recorded file on an interface for processing a recorded file according to some embodiments of the disclosure. As shown in FIG. 7, the flow includes S701, S702, and S703.

S701: in response to an operation for entering an interface for processing a recorded file from a user, a location for resuming playing in the recorded file and locating information associated with the location for resuming playing are obtained, where the locating information includes event information and a recording progress, the event information is obtained according to information from a program source of a television program corresponding to the recorded file in a recording process of the recorded file, and the locating information is generated by the display apparatus according to the received event information and the recording progress when the television program is recorded.

In some embodiments, the user may enter the interface for processing the recorded file of the television program according to a storage path of the recorded file on the display apparatus.

In some embodiments, the user may also enter the interface for processing the recorded file in a video recording application. A home page of the video recording application is configured with a recorded file managing control, and the user may click the control to enter the interface for processing the recorded file.

In some embodiments, the display apparatus obtains all recorded files in the storage path of the recorded files according to an operation for entering the interface for processing the recorded file from the user, and obtains the locations for resuming playing of each recorded file. The location for resuming playing may be stored in viewing history data of the recorded file. If the user has not yet watched the recorded file, the location for resuming playing is 0 by default. If the user has watched the recorded file, for example, the user stops watching the recorded file at the 4^{th} min, the location for resuming playing is the 4^{th} min.

In some embodiments, after the display apparatus obtains the location for resuming playing, the location for resuming playing may be compared with the recording progress of the event information in the recorded file, such that the event information associated with the location for resuming playing may be obtained. For example, locating information having a recording progress after the location for resuming playing may be eliminated, then differences between all recording progresses in the first and second locating information in the remaining process(i.e., the recording progresses not after the location for resuming playing) and the location for resuming playing may be compared, and event information corresponding to a recording progress having a minimum difference may be determined as the event information associated with the location for resuming playing.

In some embodiments, the display apparatus further obtains a maximum location of each recorded file according to the operation for entering the interface for processing the recorded file. The maximum location is an end location of a playing progress. Further a progress bar is generated according to the location for resuming playing and the maximum location.

S702: the interface for processing the recorded file is generated, where the interface for processing the recorded file includes a recorded file control corresponding to the recorded file, and the recorded file control is configured to present the location for resuming playing and the event information associated with the locating information of the location for resuming playing.

In some embodiments, after the display apparatus obtains the event information associated with the location for resuming playing, the display apparatus may generate the interface for processing the recorded file as shown in FIG. 8. As shown in FIG. 8, the interface for processing the recorded file may include a recorded file control 500. The recorded file control 500 may display a serial number 501 of the recorded file, event information 502, television program information 503, and location for resuming playing information 504. The event information 502 may display an event name and an event serial number of the location for resuming playing. The television program information 503 may display a channel code, a data format, a recorded event, recording duration, a file size and other information of the television program recorded. The location for resuming playing information 504 may include the progress bar. A viewing progress of the progress bar is the location for resuming playing.

In some embodiments, the location for resuming playing information 504 may also be text information for indicating the viewing progress, for example, “XX min and XX s has already been watched”.

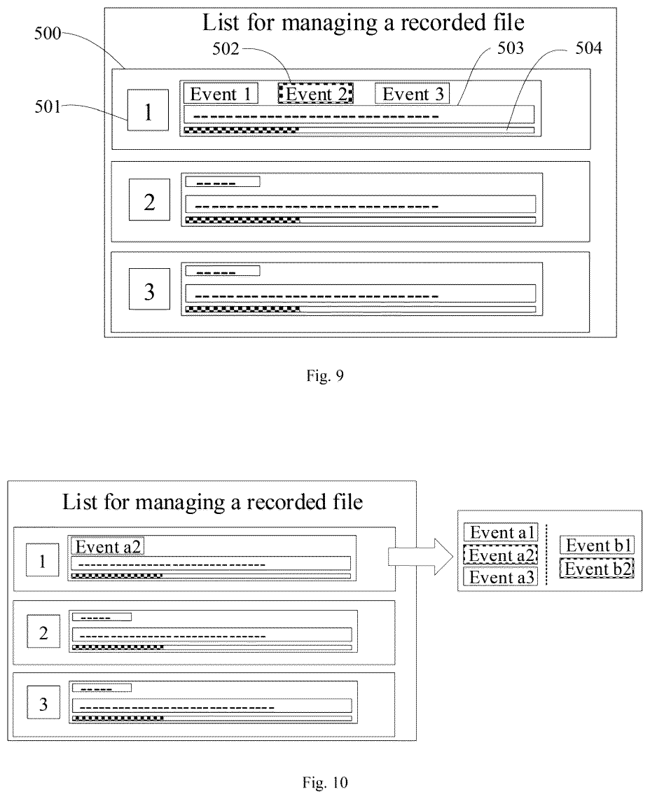

In some embodiments, with reference to FIG. 9, the serial number 501 of the recorded file, the event information 502 and the location for resuming playing information 504 are all controls which are available for user's selection. In this case, the event information 502 belongs to event controls, there may be multiple pieces of event information, and each piece of event information 502 corresponds to a piece of locating information in the recorded file.

Alternatively, there may be only one piece of the event information 502, the event information is the event control corresponding to the location for resuming playing, and the location for resuming playing information 504 is a progress bar control.

When the user enters the interface for processing the recorded file, a focus of the display apparatus is located on the serial number 501 of the recorded file that the user watches last time by default, and the progress bar control displays the location for resuming playing by default. The user may press direction keys on a remote controller to move the focus on the serial number 501 of the recorded file, the event information 502, and the location for resuming playing information 504 of each recorded file.

When the focus of the display apparatus is located on the serial number 501 of the recorded file that the user watches last time, if the user presses the ok key on the remote controller, the display apparatus may start to play the recorded file from the location for resuming playing. When the focus of the display apparatus is located on one of the pieces of event information 502, if the user presses the ok key on the remote controller, the display apparatus may obtain a recording progress in locating information corresponding to the event information 502, and play the recorded file from the recording progress. When the focus of the display apparatus is located on the location for resuming playing information 504, if the user presses the ok key of the remote controller, the user may continue to press a left direction key or a right direction key so as to adjust a target starting location. In an adjustment process, the event information 502 corresponding to the target starting location is displayed in a highlighted manner, such that the user may know recording progresses corresponding to different events, so as to select the target starting location required by the user. For example, before the user adjusts the target starting location, a current target starting location is the location for resuming playing as shown in FIG. 9. In this case, an event serial number corresponding to event 2 is displayed in a highlighted manner, and event serial numbers corresponding to event 1 and event 3 are not displayed in a highlighted manner. When the user adjusts the target starting location forward to a playing period corresponding to the event 1, the event serial number corresponding to the event 1 is displayed in a highlighted manner, and the event serial numbers corresponding to the event 2 and the event 3 are not displayed in a highlighted manner. The user may choose to start to play the recorded file at a certain location within a playing period corresponding to an event.

S703: in response to receiving a command for presenting an event, an event control corresponding to the locating information of the recorded file is generated, the display is controlled to present the event control, and an event control corresponding to the locating information of the location for resuming playing is selected by default, where the event control is configured to skip to the recording progress corresponding to the event control so as to start to play the recorded file from the recording progress.

In some embodiments, on the interface for processing the recorded file, when the focus of the display apparatus is located on the recorded file control, the user may input a command for presenting an event to the display apparatus by pressing a preset function key on the remote controller, for example, an info key (an info key).

In some embodiments, the interface for processing the recorded file may be further configured with an event presenting control. After the user moves the focus of the display apparatus from the recorded file control to the event presenting control, the user may click the event presenting control, so as to input a command for presenting an event.

In some embodiments, the command for presenting an event may also be a command generated according to an operation of the user to enter the interface for processing the recorded file, such that when the user enters the interface for processing the recorded file, the interface for processing the recorded file may present all event controls corresponding to each recorded file, and further the user may quickly select the event that the user desires to watch.

In some embodiments, after the display apparatus receives the command for presenting an event, the locating information of the recorded file may be obtained, event controls 505 corresponding to a piece of locating information are generated separately, the above event controls are presented on the interface for processing the recorded file, and the focus is set to be located on the event control corresponding to the event information of the location for resuming playing by default.

In some embodiments, the locating information of the recorded file includes first locating information and second locating information. After the display apparatus receives the command for presenting an event, the first locating information and the second locating information of the recorded file may be obtained, and event controls each corresponding to a piece of locating information are generated separately. An event control corresponding to the first locating information and an event control corresponding to the second locating information are presented separately on the interface for processing the recorded file. As shown in FIG. 10, an event a1 control, an event a2 control and an event a3 control are event controls corresponding to three pieces of first locating information respectively, and an event b1 control and an event b2 control are event controls corresponding to two pieces of second locating information respectively. The event control corresponding to the first locating information and the event control corresponding to the second locating information are presented separately, such that the user may quickly identify the event control added by the user.

In some embodiments, the event control corresponding to the first locating information may present a first identifier, and the event control corresponding to the second locating information may present a second identifier, which allows for more convenient distinguish for the user. The first identifier and the second identifier may be different symbols or texts.

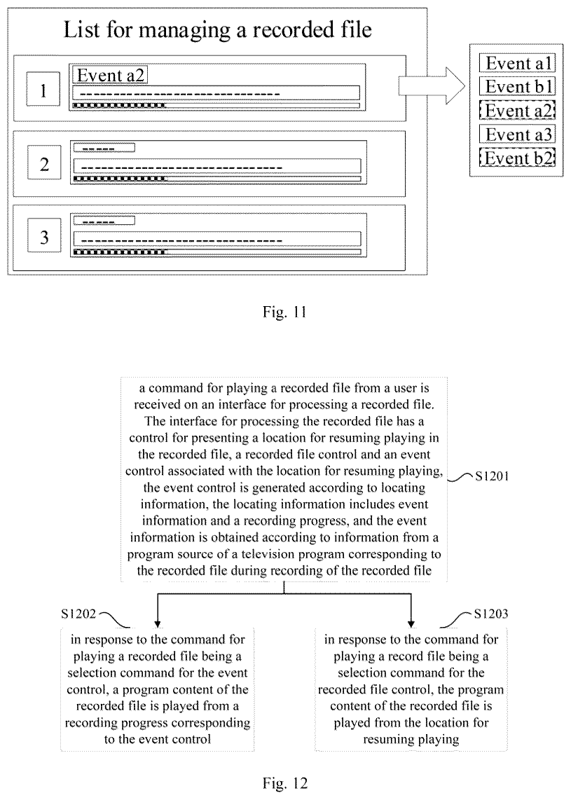

In some embodiments, the display apparatus may further present the event control corresponding to the first locating information and the event control corresponding to the second locating information on the interface for processing the recorded file in a time order of the recording progress. As shown in FIG. 11, recording progresses corresponding to the event a1 control, the event b1 control, the event a2 control, the event a3 control and the event b2 control rank in time descending order. The event control corresponding to the first locating information and the event control corresponding to the second locating information are presented in the time order of the recording progress, such that the user may quickly identify an event control corresponding to the event that the user desires to watch according to the recording progress.

In some embodiments, on the interface for processing the recorded file, the user may further add the event control into a favorite folder. One side of the event control may be configured with a favorite-adding control corresponding to the event control. The user may click the favorite-adding control so as to input a favorite-adding command, and the display apparatus responds to the favorite-adding command and sets a favorite identifier in locating information corresponding to the favorite-adding command. When the interface for processing the recorded file presents an event control, the event control with the favorite-adding identifier in the locating information may be ranked above or ahead of an event control without the favorite-adding identifier in the locating information, such that the user may quickly locate a added favorite event.

In some embodiments, the user may view the event control by moving the focus of the display apparatus. When the focus is located on one of the event controls, the user may input a command for showing event detail into the display apparatus by pressing a preset function key on the remote controller, for example, an info key.

After the display apparatus receives the command for showing event detail, the event information corresponding to the event control in focus may be obtained, an event information pop-up window 506 is generated, and the event information is presented in the event information pop-up window 506.

In some embodiments, on the interface for processing the recorded file, the user may further edit an event control, for example, deletion, modification or adding operations.

In some embodiments, the event information pop-up window 506 may present the event name, event brief, the recording progress and other information and a deletion control. The user may edit the event name, the event brief, the recording progress, and may delete locating information corresponding to the event information pop-up window 506 from the recorded file by means of the deletion control. After the user edits the event name, the event brief, the recording progress in the event information pop-up window 506, the corresponding locating information in the recorded file may also be changed accordingly.

In the above interface for processing a recorded file, an embodiment of the disclosure further provides a method for replaying a recorded file. As shown in FIG. 12, the method for replaying a recorded file may include S1201, S1202, and S1203.

S1201: a command for playing a recorded file from a user is received on an interface for processing a recorded file. The interface for processing the recorded file has a control for presenting a location for resuming playing in the recorded file, a recorded file control and an event control associated with the location for resuming playing, the event control is generated according to locating information, the locating information includes event information and a recording progress, and the event information is obtained according to information from a program source of a television program corresponding to the recorded file during recording of the recorded file.

In some embodiments, a serial number 501 of the recorded file, the event information 502 and location for resuming playing information 504 are controls which are not available for user's selection. The command for playing the recorded file on the interface for processing the recorded file may be a selection command for the recorded file control 500 or a selection command for the event control 505.

In some embodiments, a serial number 501 of the recorded file, the event information 502 and location for resuming playing information 504 are controls which are available for user's selection. The command for playing the recorded file input from the user on the interface for processing the recorded file may be a selection command for the serial number 501 of the recorded file, or a selection command for the event information 502, or a selection command for the event control 505.

In some embodiments, the user may view an event control by moving a focus of a display apparatus. When the focus is located on one of the event controls, the user may input the selection command for the event control to the display apparatus by pressing ok key on a remote controller.

In some embodiments, the locating information is on the interface for processing the recorded file. When the focus of the display apparatus is located on the recorded file control 500, the user may input a selection command for the recorded file control 500 into the display apparatus by pressing the ok key on the remote controller.

S1202: in response to the command for playing a recorded file being a selection command for the event control, a program content of the recorded file is played from a recording progress corresponding to the event control.

In some embodiments, if the command for playing a record file input from the user is the selection command for the event control, for example, the selection command for the event information 502 or the selection command for the event control 505, the display apparatus obtains the locating information corresponding to the corresponding event control, obtains the recording progress from the locating information, and starts to play the program content of the recorded file from the recording progress, such that the user may start to watch the program content of the recorded file from an initial location of the event corresponding to the event control.

S1203: in response to the command for playing a record file being a selection command for the recorded file control, the program content of the recorded file is played from the location for resuming playing.

In some embodiments, if the playing command input from the user is a selection command for the recorded file control 500, the display apparatus obtains the locating information corresponding to the recorded file control, obtains the locating information, and starts to play the program content of the recorded file, such that the program playing may resume playing program content of the recorded file from a location where the user stops watching last time.

In some embodiments, if the command for playing a record file input from the user is a selection command for the serial number 501 of the recorded file, the display apparatus obtains a progress bar control, that is, a target starting location corresponding to the location for resuming playing information 504, and the display apparatus starts to play the program content of the recorded file from the target starting location, such that the user may start to watch the program content of the recorded file from a location of a progress bar adjusted.

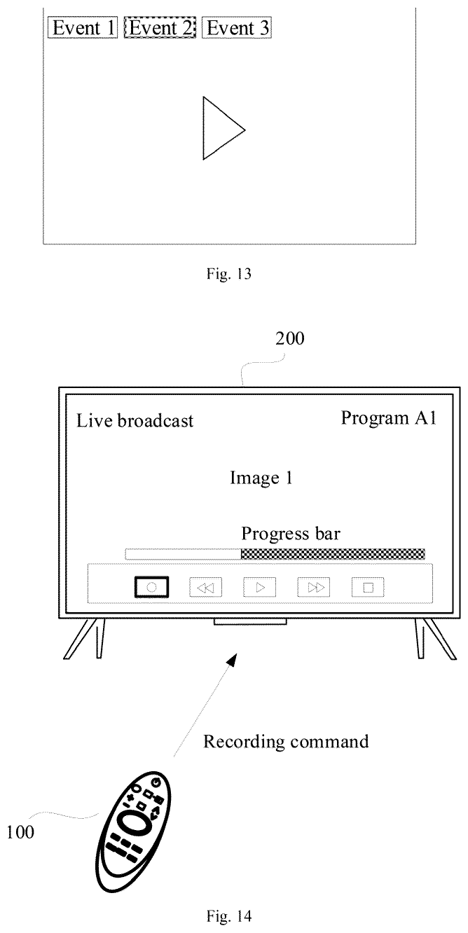

In some embodiments, in order to enable the user to conveniently skip to an event that the user desires to watch after the recorded file starts to be played, when the user enters a playing interface of the recorded file, as shown in FIG. 13, preset time of a floating layer with the event control is further displayed above the playing interface by default, which is 5s for example. In this case, the focus is located on an event control corresponding to an event being currently played by default, and the user may move the focus to event controls corresponding to other events, such that the display apparatus may enable a playing progress to skip to recording progresses corresponding to other event controls. In this way, the user may quickly switch to the event that the user desires to watch without returning to the interface for processing the recorded file after the user selects the event control corresponding to the event that the user does not desire to watch on the interface for processing the recorded file. After the preset time of the playing interface is reached, the floating layer with the event control is automatically hidden. The user may recall the floating layer with the event control so as to switch to play another event by pressing a preset key on the remote controller, for example, an info key.

According to the above embodiments of the disclosure, during recording a television program, event information from a program source is monitored in real time, and a recording progress at this time is recorded. In this way, an event control corresponding to the event information may be presented on an interface for processing a recorded file, and a user may start to watch a program content corresponding to the event information from the recording progress corresponding to the event control by directly clicking the event control. The user may quickly locate a playing location corresponding to the program content that the user is interested in when replaying the program content of the television program, and program replaying experience is improved. During recording the television program, the display apparatus automatically monitors the event information from the program source, and the user does not need to manually input the event information. If the user needs to manually input the event, the event information manually input from the user may also be received in the embodiments of the disclosure, so as to satisfy requirements of automatic and manual event creation and present the corresponding event control in a replaying interface of the program. In this way, the user may select the corresponding event and avoid repeated operations of adjusting the progress bar.

The display apparatus 200 is configured to provide the user with a function of replaying program data. The user generally regards a program in a channel as a basic unit for replaying. The program refers to a television program having a complete program content, for example, an episode of television series or a game.

FIG. 14 is a schematic diagram of a recording mode of a display apparatus according to some embodiments of the disclosure. A progress bar indicates time corresponding to program data. A gray part of the progress bar indicates program data finally recorded, that is, program data that are able to be played. For example, a time point when a display apparatus 200 is turned on is regarded as a display node of the program data (in the example, the display apparatus 200 has no channel switching operation). The display apparatus 200 is turned on and starts to play program A1 at t=0, and receives a recording command from a user at t=T1. The recording command indicates that the program data starts to be recorded at t=T1. In response to the recording command, the display apparatus 200 starts to record program data of a current program at t=T1, and ends recording at t=T2.

After recording, the user may enable a replay mode or a replay function, so as to replay a recorded video file. In a process of replaying the recorded video file, the user may play the recorded video file in order, or drag the progress bar or operate a fast forward/fast backward key so as to skip to a designated location for playing and watch a program content corresponding to the location. However, for some specific scenarios or contents in the recorded video file, the user may only roughly select a program content that the user desires to watch by frequently operating the fast forward/fast backward key, which involves cumbersome operations.

Some embodiments of the disclosure provide a method for locating and playing media. Based on event information in an EPG service, during a recording process, event information of a recorded program is saved in the recorded video file, and the event information corresponds to a recording location one by one.

In some embodiments, the media may include streaming media, which may include real audio (RA), real media (RM) of real video or audio, real text (RT), real picture, etc. If the streaming media involves a content of a third party, the streaming media needs to cooperate with the third party. The user edits a label for a specific streaming media resource, saves the label locally in the display apparatus, and then uploads the label to a front end. The user may quickly locate and play the specific streaming media resource later according to the label. The media further includes a local video file, which may be a recorded broadcast program or a media resource downloaded from a network for example. The user may manually edit the label of the media, and the label of the media may be automatically generated for the recorded broadcast program according to an EPG event. The EPG event is based on a digital television standard.

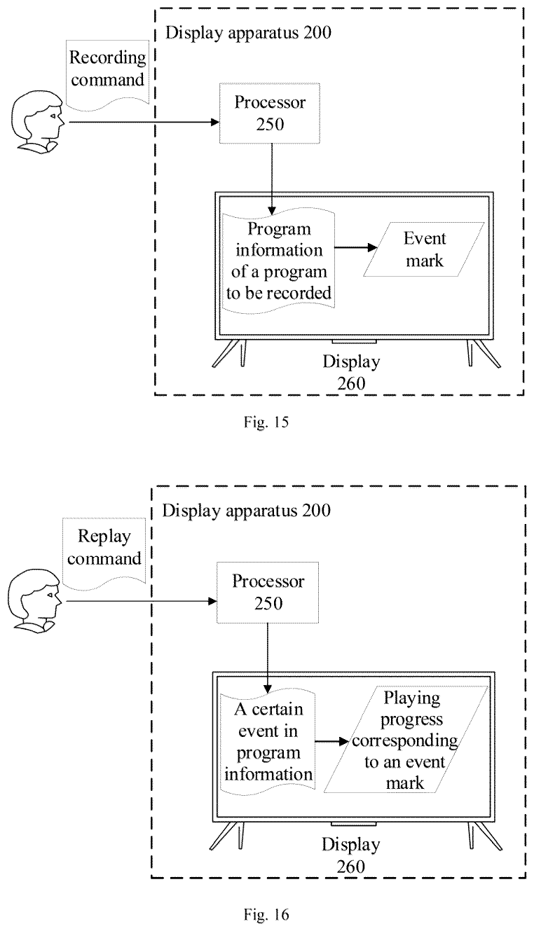

As shown in FIGS. 15 and 16, the method for locating and playing media includes a recording process and a replaying process. The display apparatus 200 may be configured to execute program steps of a method for locating and playing streaming media. The steps executed by the display apparatus 200 in the following embodiments can be implemented by at least one processor 250 working together with other components in the display apparatus 200.

S2201: a recording command from a user is obtained.

In some embodiments, the recording command may be issued by the user, and for example, during replaying a video list or generating a media file, the user may issue a recording command.

The display apparatus 200 may obtain the recording command input from the user. The recording command may be from the user, or transmitted to the display apparatus 200 by the user by means of other devices.

In some embodiments, the user may transmit the recording command to the display apparatus 200 by means of a control device 100. The control device 100 may be a remote controller, a mobile phone, a tablet computer, or other devices.

In some embodiments, the user may directly issue the recording command to the display apparatus 200. For example, a voice command, a touch command, a gesture command, etc. are directly transmitted to the display apparatus 200. The display apparatus 200 collects an action or operation of the user by means of an image collection device, a sound collection device, a touch control device, etc., or collects information or a command from the user and recognizes the recording command from the user.

In some embodiments, the user issues a recording command to the display apparatus 200 by manipulating the control device 100, and the user moves the focus to a “record” key in a user interface by pressing directional keys on the remote controller, and transmits the recording command to the display apparatus 200 by pressing an “ok” key on the remote controller, and alternatively, the user transmits the recording command to the display apparatus 200 by directly pressing the “record” key on the remote controller.

S2202: in response to the recording command, program information of a program to be recorded is obtained from the recording command.

In some embodiments, the program information of the program to be recorded may be obtained from the recording command.

In response to the recording command, the display apparatus 200 may enable a recording mode or a recording function, and present a recording parameter menu. The recording parameter menu includes recording parameters which can be configured and an editing area corresponding to each recording parameter. In some embodiments, the recording parameters include start time of recording, end time of recording, the recording mode, and the corresponding editing area (text box).

In some embodiments, the at least one processor 250 receives a command, for setting a recording parameter, from a user; in response to the command for setting a recording parameter, causes a display to present a user interface with the recording parameter menu, where the recording parameter menu includes at least one recording parameter and an editing area corresponding to the at least one recording parameter; receives an editing command from the user, where the editing command is configured to indicate the editing area to be edited and an editing content; and, in response to the editing command, causes the editing content to fill the editing area.

In some embodiments, the recording command is issued by the user and transmitted to a recording module through an operation interface.

In some embodiments, the user issues a command for setting a recording parameter to the display apparatus 200 by manipulating the control device 100, so as to instruct the display apparatus 200 to input corresponding editing content into the text box and complete setting of the recording parameter. In some embodiments, in order to facilitate setting for the user, for example, in order to avoid the situation that the user cannot accurately know start time of playing and end time of playing of a target program and cannot accurately determine the start time of recording and the end time of recording, the display apparatus 200 may analyze a program name provided by the program data in the recording parameter menu and the start time of playing and the end time of playing corresponding to the program, such that the user may indirectly select the start time of recording and the end time of recording by directly selecting the program name of the target program. The start time of recording is before or equal to the start time of playing of the target program, and the end time of recording is later than or equal to the end time of playing of the target program.

In some embodiments, before a video file is recorded, the at least one processor 250 obtains an event information table (EIT) in an EPG table. The event information table includes an event or data related to description of an event content, such as an event name, start time, a time length, a running state, and detailed description of the event. Specifically, the recording command from the user is received, a recording request is obtained from the recording command, an electronic program guide related to the recording request is obtained, and basic event information of each event of the program to be recorded in the recording request is obtained according to the electronic program guide. The program to be recorded in the disclosure includes, but is not limited to, a television program, a broadcasting program, and a short video program. The method for locating and playing media according to the disclosure will be described below only by taking the program to be recorded as the television program.

In some embodiments, the EIT is a basic table of an EPG generated on the basis of a digital television standard, and includes an event name, start time and end time of the event, etc. in EIT information.

In some embodiments, the basic event information may have fields such as event_id, start_time, duration and event_name in a standard digital television protocol.

Assuming that the user sets to record a television program in channel N from 13:00 to 16:00 on date XX, before the television program starts to be recorded, basic event information in a recorded video file correspondingly set by the user in the television program played in the channel N from 13:00 to 16:00 on date XX is obtained according to an EPG related to a recording request, and each event and start time of each event are recorded. For example, corresponding video files to be recorded which are set by the user include event 1 (a movie program), event 2 (a news program), and event 3 (a food program) according to the EPG, and the start time of each event is obtained. For example, the start time of the event 1 is 13:00, the start time of the event 2 is 14:30, and the start time of the event 3 is 15:00.

S2203: in response to an event currently being played being the program to be recorded, a playing progress of a current event is obtained.

In some embodiments, the display apparatus 200 obtains the event currently being played by analyzing program data currently received, so as to determine end time of playing of a corresponding current program according to the event currently played, and determines that a program required to be recorded is the program to be recorded, that is, a target program, by comparing the start time of recording with the end time of playing of the current program. When the start time of recording is before the end time of playing of the current program, the target program is the current program. When the start time of recording is after or equal to the end time of playing of a current program content, the target program refers to the program to be played after the current program.

In some embodiments, the current program is program A1, and the end time of playing of the program A1 is T3. If the start time of recording set by the user is T2, and T2<T3, it may be determined that the target program to be recorded by the user is the program A1. If the start time of recording set by the user is T4, and T4>T3, it may be determined that the target program to be recorded by the user is the program to be played after the program A1, for example, program A2.

In some embodiments, when the event currently played is the program to be recorded, the display apparatus 200 determines whether the event currently played is stored on the basis of the event information of the program to be recorded. Execution of the recording command is terminated when the event currently played is already stored. The playing progress of the current event is obtained when the event currently played is not stored.

S2204: an event mark is set in the recorded video file according to the playing progress of the current event.

The at least one processor 250 calculates a location of the event currently played on the progress bar on the basis of time data obtained by analyzing data of the event currently played, so as to obtain the playing progress of the event currently played; match a playing progress of the event currently played with the event information corresponding to the playing progress; and obtains a time point of the occurrence time of the event information matched on the playing progress, and sets the event mark corresponding to the time point on the playing progress.

After the event mark is set in the recorded video file, the at least one processor 250 extracts media data of each event from the recorded video file; and saves an event serial number, an event name, an initial location of the event and media data. The at least one processor 250 extracts clear stream data of each event in the recorded video file according to the basic event information obtained. In the embodiments of the disclosure, the clear stream data extracted is generally a certain frame of video data in each event. The clear stream data of each event is configured to represent each corresponding event. The at least one processor 250 sets a moment for extracting the clear stream data of each event according to the basic event information obtained. When the recorded program reaches the moment for extracting the clear stream data of the event, the clear stream data at the moment is extracted.

During recording of the television program, the at least one processor 250 extracts the clear stream data of each event at a start moment in the recorded video file according to the basic event information obtained. In some embodiments, the at least one processor 250 monitors event changes during recording and obtaining a target recorded file according to the obtained basic event information of each event in the target recorded file; and extracts a first frame of clear stream data of the event when an event changes. The clear stream data at the start moment of each event may best represent the event. For example, when the television program in channel N from 13:00 to 16:00 on date XX is recorded, according to start time of the event, clear stream data corresponding to 13:00 in the recorded file is extracted as clear stream data of the event 1, clear stream data corresponding to 14:30 in the recorded video file is extracted as clear stream data of the event 2, and clear stream data corresponding to 15:00 in the recorded video file is extracted as clear stream data of the event 3.

In the embodiments of the disclosure, the obtained clear stream data of each event is saved in a format of a cache file, such that use of the clear stream data may be improved, and further storage safety of the clear stream data may be ensured. During recording of the television program, when clear stream data of an event is extracted, the event is recorded, and for example, the event serial number, the initial location of the event, the event name and the clear stream data are recorded. For example, a first event is defined as the event 1, and meanwhile, an initial location 0 of a video and the event name are saved. When the event changes after 30 s, a second event is defined as the event 2, and an initial location 30 and the event name are saved. The event information corresponding to each event is saved for centralized management of all the events in the recorded file, so as to use a content in the event information in subsequent steps.

Due to limited event information in the EPG, only event information of a certain time period is recorded, and event information of a plurality of sub-events or a specific event belonging to the event is not recorded.

In some embodiments of the disclosure, the at least one processor 250 in the display apparatus 200 is further configured to obtain a keyword from the recording command; determine at least one target image frame according to the keyword; match a playing progress of an event corresponding to the target image frame with event information corresponding to the playing progress according the playing progress; and obtain a corresponding time point of the event information including the target image frame on the playing progress, and set the playing progress according to the time point.

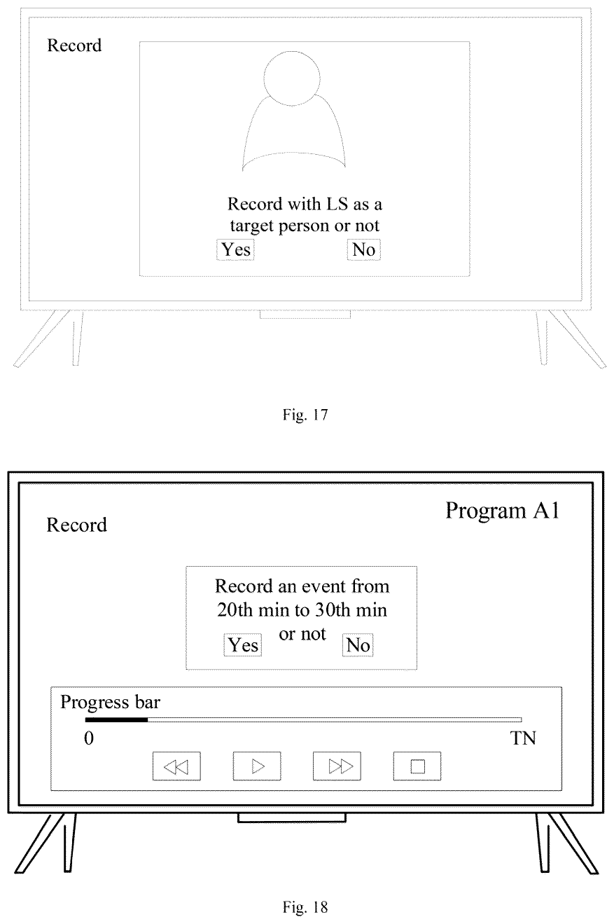

As shown in FIG. 17, assuming that the user sets to record a television program in channel N from 13:00 to 16:00 on date XX, before starting to record the television program, basic event information in a recorded video file is obtained according to an electronic program guide associated with a recording request, where the recorded video file corresponds to the television program in the channel N from 13:00 to 16:00 on date XX set by the user, and each event and a start time of each event are recorded. The recorded video file includes an event 1 (a movie program), an event 2 (a news program), and an event 3 (a food program) according to the electronic program guide, and the start time of each event is obtained. For example, the start time of the event 1 is 13:00, the start time of the event 2 is 14:30, and the start time of the event 3 is 15:00. The user takes the event 1 as a program to be recorded, and legendary lives of ZS and LS are played in the movie program. The user watches the legendary life of ZS before but does not watch the legendary life of LS, and the user only wants to watch the legendary life of LS in the event 1, so a recording command from the user also has a keyword “LS”. When the recording function is enabled, the display apparatus 200 determines at least one target image frame according to the keyword “LS” and records a location of a sub-event “LS” corresponding to the target image frame on the progress bar, so as to obtain a playing progress of the sub-event “LS”; matches the playing progress of the sub-event “LS” with event information corresponding to the playing progress; and obtains a corresponding time point of occurrence time of the event information including the sub-event “LS” of the target image frame on the playing progress, and sets an event mark of the sub-event “LS” on the playing progress according to the time point. It is noted that the occurrence time of the event information including the sub-event “LS” may be plural, that is to say, there may be a plurality of event marks for the sub-event “LS” on the playing progress according to a plurality of time points determined.

In some embodiments of the disclosure, the at least one processor 250 is further configured to obtain a key time point from the recording command, and determine a determination interval according to the key time point; and set the event mark on the playing progress according to the time point if the time point corresponding to the event currently played is within the determination interval.

As shown in FIG. 18, assuming that a user sets to record a television program in channel N from 13:00 to 16:00 on date XX, video files to be recorded which are set by the user include event A1 (a food program), event A2 (a news program), and event A3 (a movie program) according to an electronic program guide, and a start time of each event is obtained. For example, the start time of the event A1 is 13:00, the start time of the event A2 is 14:30, and the start time of the event A3 is 15:00. The event A1 is determined as a program to be recorded, and a complete collection of cooking with sauce is played in the food program. It is known that a section of pork cooking with sauce is played at 13:20-13:30 according to a program preview.

The section of pork cooking with sauce in the event A1 is content of interest for the user, so the recording command input from the user also has key time points “13:20-13:30”. When the recording function is enabled, the display apparatus 200 determines the determination interval according to the time points “13:20-13:30”. When the time point corresponding to the event currently played is within the determination interval, the event mark is set on the playing progress according to the time point.

Based on the keyword and the key time point(s) in the recording command, the user may set clips of interested content or actor clips, in the program to be recorded by himself/herself, and quickly locate favorite program clips of or actor clips according to a program information table on the user interface through the replay mode or replay function, so as to improve locating and searching efficiency.

S2205: recording is terminated when playing of the program to be recorded ends, and the recorded video file is obtained.

The at least one processor 250 extracts clear stream data from event information of an event corresponding to a playing progress of the recorded file according to the playing progress; and obtains the event information of the first event when recording of the recorded file ends, extracts clear stream data from the event information of the first event, and processes and sets the clear stream data to associate with an icon of the recorded video file, where the icon of the recorded video file is displayed as a thumbnail from the clear stream data. In the embodiment, according to the icon of the target recorded file after the obtained clear stream data of the corresponding event is processed, the thumbnail is generated by processing the obtained clear stream data of the corresponding event by processing the size and the pixel, and then the thumbnail is set as the icon of the target recorded file.

In some embodiments, after recording of the recorded video file is completed, if the target recorded file is played, according to the playing progress of the target recorded file, clear stream data is extracted from the event information of the event corresponding to the playing progress, the clear stream data is set to associate with the icon of the target recorded file, and further the icon of the target recorded file is displayed as an icon for showing the clear stream data. For example, when the second event of the recorded file starts to be played, an image of the clear stream data from the event information corresponding to the second event is selected as a thumbnail of the recorded file. In this way, when recording of the target recorded file is completed or the user completes replaying, the icon of the target recorded file may be displayed based on the content of the event corresponding to the playing progress on the basis of the playing progress of the recorded file. For example, when recording of the television program in channel N from 13:00 to 16:00 on date XX is completed, the target recorded file is obtained, an image from the clear stream data of the event 1 is processed to be the icon of the target recorded file, and the icon of the target recorded file is displayed based on the content of the clear stream data of the event 1. When the file to be recorded is played, before the television program is played to 5400 seconds, an image processed from the clear stream data of the event 1 is used as the icon of the target recorded file, and the icon of the target recorded file is displayed based on the content of the clear stream data of the event 1. When the television program is played to a play period between 5400 seconds to 7200 seconds, an image processed from clear stream data of the event 2 is used as the icon of the target recorded file, and the icon of the target recorded file is displayed based on the content of the clear stream data of the event 2. When the television program is played from 7200 seconds to the end of the television program, an image processed from the clear stream data of the event 3 is used as the icon of the recorded file, and the icon of the target recorded file is displayed based on the content of the clear stream data of the event 3.

S2206: in response to a replay command, the recorded video file is replayed.

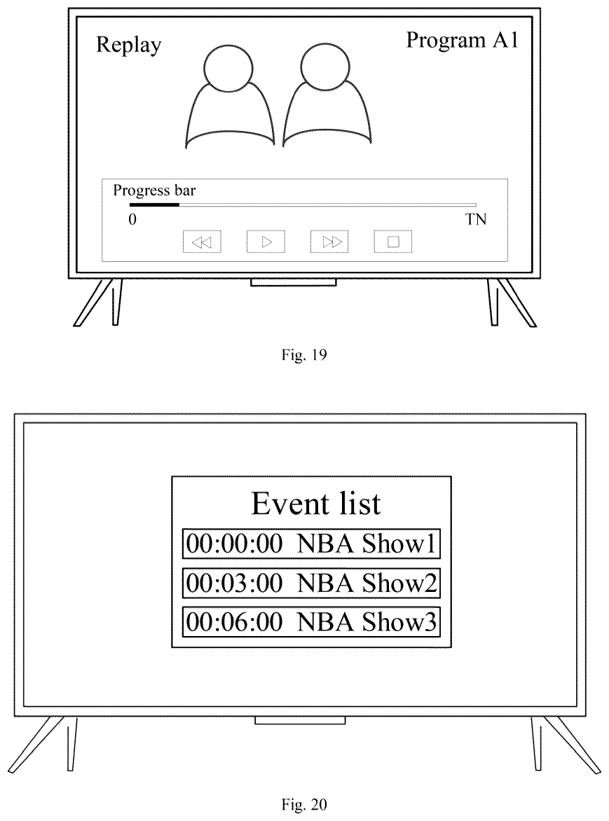

After recording is completed, the at least one processor 250 automatically disables the recording function and enables the replay mode or the replay function in response to the replay command. For example, the user issues the replay command to the display apparatus 200 by manipulating the control device 100, and the display apparatus 200 may control the display 260 to display the user interface corresponding to the recorded video file in response to the replay command. As shown in FIG. 19, the user interface includes a program name, a replaying identifier, a progress bar which can be adjusted, etc. corresponding to the target program. The user may accurately know that replaying instead of live broadcast is currently conducted, accurately know the program being replayed, and adjust the playing progress by adjusting the progress bar.

S2207: upon receiving an operation for selecting an event, the progress bar skips to a playing progress marked associated with the event.

In the replaying process, the at least one processor 250 causes the display 260 to call the list of all pieces of event information included in the recorded video file in response to an operation from the user. As shown in FIG. 20, when the operation for selecting an event from a user is received, the at least one processor 250 is configured to move the playing progress bar to the playing location corresponding to the event marked associated with the event and starts playing. In this way, operation convenience is greatly improved.

In the recording process, cached program data may be void, and alternatively, the cached program data has no content. In some embodiments of the disclosure, when receiving an operation for selecting a target event, the at least one processor is further configured to: detect a time point in a playing progress corresponding to the target event; if the time point corresponding to the target event exists, move to a marked location of the target event; or alternatively, control the display to present error information on the user interface if the time point corresponding to the target event does not exist. In this way, the problem of void cached program data may be avoided.

In order to improve operation convenience, in some embodiments of the disclosure, the at least one processor 250 is further configured to obtain a keyword from the replay command; determine at least one target image frame according to the keyword; traverse the recorded video according to the target image frame, so as to search for the target event including the target image frame; obtain a time point of the target event on the playing progress, and set a target event mark corresponding to the time point on the playing progress; and skips to the time point with the target event mark on the playing progress bar upon receiving an operation for selecting a target event.

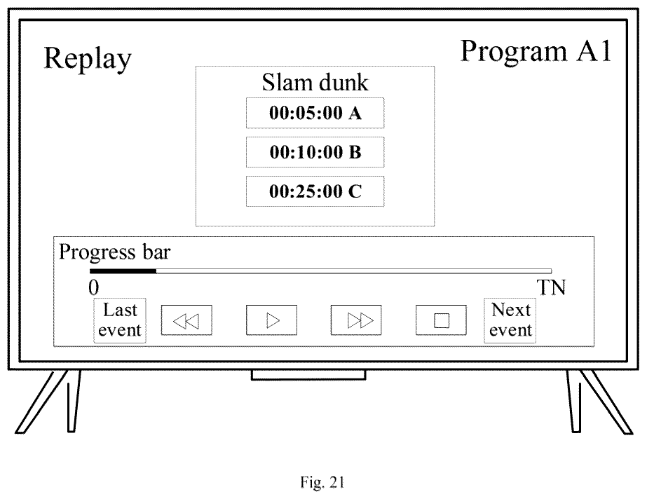

As shown in FIG. 21, the display apparatus 200 enables the replay mode or the replay function in response to the replay command input from the user, and the display apparatus 200 obtains a keyword “slam dunk” from the replay command, and determines at least one target image frame according to the keyword “slam dunk”. The display apparatus 200 traverses the recorded video file and searches for one or more target events including the target image frame from the recorded video file. The display apparatus 200 obtains a plurality of target events, and obtains time points corresponding to the target events on the playing progress bar. The display apparatus 200 sets target event marks corresponding to the time points on the playing progress. In response to an operation from the user, the display apparatus 200 controls the display 260 to display a list of all the pieces of event information on the user interface. When the display apparatus 200 receives an operation for selecting an event “slam dunk A”, the playing progress bar is enabled to skip to a playing time with the event mark “slam dunk A”.

In the video recording process, the display apparatus 200 obtains the EPG of the program to be recorded, records all the pieces of event information of the program to be recorded in the video recording process, associates the event information with the recorded video file, and stores the event information in the apparatus. In the replaying process, all the pieces of event information are loaded, and the user may quickly and accurately locate the video program content that the user desires to watch according to the event information, and may directly skip to the program content for playing. By using the method, the user may quickly and accurately select and watch the program of interest from the recorded video file, such that the problem of wasting a lot of time watching irrelevant programs or wasting energy and time to search for the time point when the user desires to start watching through constant fast forward and fast backward is solved, locating efficiency of replaying is improved, fixed-point replaying operations are reduced, and repeated operations of adjusting the progress bar are reduced.

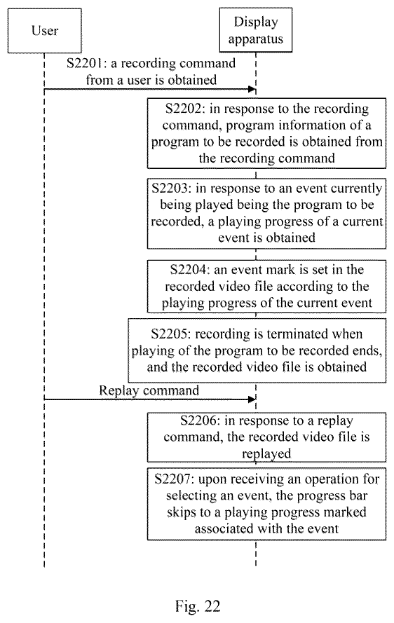

Based on the above method for locating and playing streaming media, as shown in FIG. 22, some embodiments of the disclosure further provide a display apparatus. The display apparatus includes a display 260 and at least one processor 250. The display 260 is configured to display an image from broadcast system or network and/or a user interface. The at least one processor 250 is configured to perform S2201-S2207 as shown in FIG. 22.

Some embodiments of the disclosure provide a display apparatus and a method for locating and playing streaming media. Based on the method for locating and playing streaming media, program information of a program to be recorded may be obtained from a recording command according to a recording command; when an event currently played is the program to be recorded, a playing progress of a current event may be obtained; according to the playing progress of the current event, an event mark may be set in a recorded video file; the recorded video file is replayed in response to a replay command; and when an operation for selecting an event is received, the progress bar skips to a corresponding playing progress of the event marked. In the recording process, all the pieces of event information are recorded, and the user may quickly and accurately locate the video program content that the user desires to watch according to the event information, and may directly skip to the program content for playing, so as to reduce operations from the user.

Finally, it should be noted that the above embodiments are merely used to illustrate embodiments of the disclosure, rather than limiting the same. Although the disclosure has been described in detail with reference to the foregoing embodiments, those of ordinary skill in the art should understand that the foregoing embodiments can still be modified, or some or all of the features therein can be substituted However, these modifications or substitutions do not make the essence of the corresponding embodiments deviate from the scope of the disclosure.

What is claimed is:

1. A display apparatus, comprising:
a display configured to display an image from a broadcasting system, a network and/or a user interface;
a communicator configured to be in communication with the network;
a remote controller comprising a plurality of keys;
a memory configured to store instructions and data associated with the display; and
at least one processor in connection with the display, the communicator and the memory, and configured to execute the instructions to cause the display apparatus to perform:
in response to a command for entering an interface for processing a recorded file, obtaining one or more locations for resuming playing corresponding to one or more recorded files and one or more pieces of locating information for the one or more locations for resuming playing in the memory, wherein one of the one or more pieces of locating information comprises event information and a recording progress, the event information is obtained according to information from a program source of a television program corresponding to the recorded file, and the one or more pieces of locating information is generated by the display apparatus according to the event information obtained from the program source and the recording progress during recording of the television program;
generating the interface for processing the recorded file and presenting the interface for processing the recorded file on the display, wherein the interface for processing the recorded file comprises a first recorded file control, and the first recorded file control is configured to present a location for resuming playing for a first recorded file and the event information in the locating information for the first recorded file; and
in response to a command for displaying an event in the first recorded file, generating one or more event controls corresponding to one or more pieces of locating information in the first recorded file, presenting the one or more event controls on the display, and selecting a first event control by default, wherein the first event control among the one or more event controls is configured to skip to a first recording progress corresponding to the first event control for playing a portion of the first recorded file from the first recording progress, and the one or more pieces of location information in the first recorded file comprises a piece of locating information for the location for resuming playing for the first recorded file and one or more pieces of locating information for one or more events in the first recorded file.

2. The display apparatus according to claim 1, wherein the at least one processor is further configured to execute the instructions to cause the display apparatus to perform:
generating one or more event controls of a first type corresponding to the one or more pieces of locating information generated according to information from the program source corresponding to the first recorded file, wherein each of the one or more event controls of the first type is configured with a first identifier visible on the display.

3. The display apparatus according to claim 2, wherein the at least one processor is further configured to execute the instructions to cause the display apparatus to perform:
generating one or more event controls of a second type corresponding to locating information generated according to information input from a user, wherein
each of the one or more event controls of the second type is configured with a second identifier visible on the display.

4. The display apparatus according to claim 3, wherein the at least one processor is further configured to execute the instructions to cause the display apparatus to perform:
causing the display to present the one or more event controls of the first type and the one or more event controls of the second type.

5. The display apparatus according to claim 1, wherein the at least one processor is further configured to execute the instructions to cause the display apparatus to perform:
in response to an operation for adjusting a progress via a progress bar control from a user, obtaining a target starting location corresponding to the operation, and updating a starting location on the progress bar control from the location for resuming playing to the target starting location;
obtaining locating information associated with the target starting location; and
presenting an event control corresponding to the locating information associated with the target starting location in a highlighted manner.

6. The display apparatus according to claim 1, wherein the at least one processor is further configured to execute the instructions to cause the display apparatus to perform:
filtering the one or more pieces of locating information for a match piece of locating information whose recording progress is before the location for resuming playing in time and has a minimum difference from the location for resuming playing among one or more differences between the location for resuming playing and recording progresses of some pieces of the one or more pieces of locating information before the location for resuming playing in time.

7. The display apparatus according to claim 1, wherein the at least one processor is further configured to execute the instructions to cause the display apparatus to perform:
receiving a selection command for the first event control among the one or more event controls for the first recorded file; and
in response to the selection command for the first event control, playing a portion of the first recorded file from the recording progress corresponding to the first event control.

8. The display apparatus according to claim 1, wherein the event information comprises one or more of: channel information of a channel to which an event belongs, program information of a program to which the event belongs, an event name, start time of the event, a time duration of the event, a running state of the event, or detailed description of the event.

9. The display apparatus according to claim 1, wherein the at least one processor is further configured to execute the instructions to cause the display apparatus to perform:
monitoring event information from the program source of the television program;
determining whether the event information received corresponds to the television program being recorded by the display apparatus;
in response to the event information received corresponding to the television program being recorded, obtaining a recording progress of the television program, and generating a piece of locating information comprising the event information received and the recording progress obtained; and
in response to the event information not corresponding to the television program being recorded, not processing the event information received.

10. The display apparatus according to claim 1, wherein the at least one processor is further configured to execute the instructions to cause the display apparatus to perform:
upon receiving a first event information table (EIT) from the program source for a first time, storing the first EIT locally in the display apparatus;
upon receiving a second EIT following the first EIT, determining whether event information in the second EIT is the same as historical event information in the first EIT;
in response to the event information in the second EIT being same as the historical event information in the first EIT, not processing the second EIT receive, and
in response to the event information in the second EIT being different from the historical event information in the first EIT, storing the second EIT locally and generating an event update notification associated with the event information in the second EIT.

11. A method for processing recorded data in a display apparatus, comprising:
in response to a command for entering an interface for processing a recorded file, obtaining one or more locations for resuming playing corresponding to one or more recorded files and one or more pieces of locating information for the one or more locations for resuming playing in the memory, wherein one of the one or more pieces of locating information comprises event information and a recording progress, the event information is obtained according to information from a program source of a television program corresponding to the recorded file, and the one or more pieces of locating information is generated by the display apparatus according to the event information obtained from the program source and the recording progress during recording of the television program;
generating the interface for processing the recorded file and presenting the interface for processing the recorded file on a display of the display apparatus, wherein the interface for processing the recorded file comprises a first recorded file control, and the first recorded file control is configured to present a location for resuming playing for a first recorded file and the event information in the locating information for the first recorded file; and
in response to a command for displaying an event in the first recorded file, generating one or more event controls corresponding to one or more pieces of locating information in the first recorded file, presenting the one or more event controls on the display, and selecting a first event control by default, wherein the first event control among the one or more event controls is configured to skip to a first recording progress corresponding to the first event control for playing a portion of the first recorded file from the first recording progress, and the one or more pieces of location information in the first recorded file comprises a piece of locating information for the location for resuming playing for the first recorded file and one or more pieces of locating information for one or more events in the first recorded file.

12. The method according to claim 11, further comprising:
generating one or more event controls of a first type corresponding to the one or more pieces of locating information generated according to information from the program source corresponding to the first recorded file, wherein each of the one or more event controls of the first type is configured with a first identifier visible on the display.

13. The method according to claim 12, further comprising:
generating one or more event controls of a second type corresponding to locating information generated according to information input from a user, wherein
each of the one or more event controls of the second type is configured with a second identifier visible on the display.

14. The method according to claim 13, further comprising:
causing the display to present the one or more event controls of the first type and the one or more event controls of the second type.

15. The method according to claim 11, further comprising:
in response to an operation for adjusting a progress via a progress bar control from a user, obtaining a target starting location corresponding to the operation, and updating a starting location on the progress bar control from the location for resuming playing to the target starting location;
obtaining locating information associated with the target starting location; and
presenting an event control corresponding to the locating information associated with the target starting location in a highlighted manner.

16. The method according to claim 11, further comprising:
filtering the one or more pieces of locating information for a match piece of locating information whose recording progress is before the location for resuming playing in time and has a minimum difference from the location for resuming playing among one or more differences between the location for resuming playing and recording progresses of some pieces of the one or more pieces of locating information before the location for resuming playing in time.

17. The method according to claim 11, further comprising:
receiving a selection command for the first event control among the one or more event controls for the first recorded file; and
in response to the selection command for the first event control, playing a portion of the first recorded file from the recording progress corresponding to the first event control.

18. The method according to claim 11, wherein the event information comprises one or more of: channel information of a channel to which an event belongs, program information of a program to which the event belongs, an event name, start time of the event, a time duration of the event, a running state of the event, or detailed description of the event.

19. The method according to claim 11, further comprising:
monitoring event information from the program source of the television program;
determining whether the event information received corresponds to the television program being recorded by the display apparatus;
in response to the event information received corresponding to the television program being recorded, obtaining a recording progress of the television program, and generating a piece of locating information comprising the event information received and the recording progress obtained; and
in response to the event information not corresponding to the television program being recorded, not processing the event information received.

20. The method according to claim 11, further comprising:
upon receiving a first event information table (EIT) from the program source for a first time, storing the first EIT locally in the display apparatus;
upon receiving a second EIT following the first EIT, determining whether event information in the second EIT is the same as historical event information in the first EIT;
in response to the event information in the second EIT being same as the historical event information in the first EIT, not processing the second EIT receive, and
in response to the event information in the second EIT being different from the historical event information in the first EIT, storing the second EIT locally and generating an event update notification associated with the event information in the second EIT.
